(19) United States
(12) Patent Application Publication
(10) Pub. No.: US 2011/0104309 A1
(43) Pub. Date: May 5, 2011

(54) INHIBITION OF BACTERIA THROUGH APPLICATION OF A DILUTED SOLUTION OF A SILICATE CHEMICAL

(75) Inventors: Earl Ben Elledge, Sugar Land, TX (US); Don Lambert, Dallas, TX (US); George Stapleton, Sugar Land, TX (US)

(73) Assignee: SILICON SOLUTIONS LLC, Sugar Land, TX (US)

(21) Appl. No.: 12/793,197

(22) Filed: Jun. 3, 2010

Related U.S. Application Data
(60) Provisional application No. 61/184,093, filed on Jun. 4, 2009.

(51) Int. Cl. A01N 59/00; A01P 1/00

(52) U.S. Cl. 424/722; 424/600

(57) ABSTRACT

The present invention is directed to methods of inhibiting bacterial growth and reproduction. In particular, the present invention relates to methods of inhibiting bacterial growth comprising contacting bacteria with aqueous solutions of silicon.

### FIELD OF THE INVENTION

The present invention generally relates to methods of using aqueous silicon solutions. In particular, the present invention relates to methods of inhibiting bacteria with aqueous silicon solutions.

### BACKGROUND OF THE INVENTION

Current methods of inhibiting the growth and reproduction of bacteria typically rely on treating bacteria with antibiotics. In cleaning and prophylactic efforts the combinations of “anti-bacterial” chemicals and antibiotics are thought to contribute to the development of antibiotic resistant strains of bacteria. Further, many “anti-bacterial” chemicals are themselves dangerous to handle.

Thus, there is a need for alternative methods of inhibiting bacterial growth and reproduction.

Silicon is well known in the art for providing an effective coating for use in a variety of applications. For example, silicon is often used to coat metals, thereby reducing corrosion of the metal. Previously, one of the disadvantages associated with the use of silicon has been the difficulty of providing silicon in an aqueous medium.

U.S. Pat. No. 7,293,568 and published U.S. Patent Application 2008-0178908, each of which is herein incorporated by reference in their entirety, teach methods of making stable, aqueous solutions of silicon. In particular, these documents disclose an aqueous silicon solution comprising SiO₂ and Na₂O, wherein the ratio of SiO₂ to Na₂O, by mass, is at least 3.8 and wherein the solution has a pH of at least 11, and has low reactivity and/or corrosivity. This solution is made by providing a vessel having cone shaped bottom and containing a predetermined amount of silicon rock, wherein the silicon rock comprises at least 99 molar percent silicon and 0.393 molar percent iron; introducing a predetermined quantity of water into the vessel in such a manner as to provide contact with the rock; adding a predetermined amount of NaOH solution to the rock and water through the bottom of the vessel, thereby forming a reaction mixture; allowing the reaction to run for 10-14 hours to thereby form a reacted solution; offloading the reacted solution to a settling tank; allowing the reacted solution to settle for 2-4 days to thereby form a settled reacted solution; moving the settled reacted solution to a second settling tank for 10 days; moving the settled reacted solution to a bulk storage tank; exposing the settled reacted solution to ultraviolet radiation to form an aqueous silicon solution; and diluting the aqueous silicon solution with water to form a diluted aqueous silicon solution

It has been unexpectedly discovered that aqueous solutions of silicon have antimicrobial properties. The instant invention provides novel methods of inhibiting bacteria with aqueous silicon solutions.

### SUMMARY OF THE INVENTION

The present invention generally relates to a formulation created by reacting sodium hydroxide, water, and silicon metal, which has unique properties and many uses.

The present invention also relates to methods of inhibiting bacteria by contacting the bacteria with aqueous silicon solutions.

The present invention further relates to methods of washing and cleaning surfaces with aqueous solutions of silicon in order to inhibit Gram-negative and Gram-positive bacteria.

The present invention further relates to various cleaning and treating agents manufactured using formulations comprising aqueous solutions of silicon.

The present invention further relates to cleaning products, such as sponges, mops, towels, and the like, that have been impregnated with aqueous silicon solutions.

The present invention also relates to methods of treating crops and animals for bacterial contamination comprising contacting the crops or animals with aqueous silicon solutions.

One embodiment of the invention encompasses a stable, aqueous solution comprising SiO₂ and Na₂O, wherein the ratio of SiO₂ to Na₂O, by mass, is at least 3.8.

Another embodiment of the present invention relates to methods of inhibiting bacteria comprising contacting the bacteria with a stable, aqueous solution comprising SiO₂ and Na₂O, wherein the ratio of SiO₂ to Na₂O, by mass, is at least 3.8.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The present invention generally relates to a formulation created by reacting sodium hydroxide, water, and silicon metal, which has unique properties and many uses. In particular, the present invention further relates to the unexpected finding that such solutions inhibit the growth and reproduction of Gram-negative and Gram-positive bacteria. The present invention further relates to various cleaning and treating methods and compositions manufactured using formulations comprising aqueous solutions of silicon.

Compositions for use in the methods of the instant invention are stable complexes of silicon metal in an aqueous solution. Such compositions may be produced in accordance with the steps outlined in U.S. Pat. No. 7,293,568 and published U.S. Patent Application 2008-0178908, each of which is herein incorporated by reference in their entirety.

The aqueous silicon solution is mixed with water into a 3% solution and used as a cleaner or bath to inhibit the growth and reproduction of bacteria, including Methicillin-Resistant Staphylococcus Aureus (MRSA) bacteria, as well as a wide range of other Gram-negative and Gram-positive bacteria. Bacteria strains that may be inhibited by the use of aqueous silicon solutions include, but are not limited to:
Escherichia coli (E. coli)
Salmonella enteriditis
Salmonella typhi
Enterobacter
Heliobacter
Yersinia pestis (Bubonic plague)
Brucella
Legonella pneumophila (Legionnaire's disease)
Meningosepticum (Infant Meningitis)
Vibrio Cholerae (Cholera)

Aqueous silicon solutions in accordance with the instant invention may be used in all manner of delivery systems. Aqueous silicon solutions in accordance with the present invention may be used as one would use soaps or other cleaning agents. In short, compositions in accordance with the present invention may be used as one would use any contemporary topically applied antimicrobial composition.

Preferably, the aqueous silicon solution is topically applied in a 0.5-3.0% solution mixed with fresh water. No heat, agitation, or mixing are required. Straight application has resulted in >99% percent morbidity for all forms of Gram-negative and Gram-positive bacteria tested to date. It is an object of this invention to provide aqueous silicon solutions, either in dilutable or in neat form that can be used in conjunction with sponges, cloths, rags, paper towels and the like. Such products can function as stand-alone products or can be used in combination with conventional cleaning implements including sponge mops, string mops, strip mops or used with an absorbent disposable cleaning pad that is optionally attached to a cleaning implement comprising a handle and mop head. The aqueous silicon solution may also be incorporated into cleaning sprays or drips to clean surfaces and inhibit Gram-negative and Gram-positive bacteria. The aqueous silicon solution may be sprayed or used as a bath for treatment of bacteria on crops or domestic animals.

### Example 1

Aqueous solution of silicon, ERA-3, was tested to determine its efficacy in methods of inhibiting Gram-negative and Gram-positive bacteria.

The method used was the broth macrodilution method for susceptibility testing of antibacterial agents as recommended by the Clinical and Laboratory Standards Institute (CLSI) for clinical laboratories. The detailed procedure was as follows:

1. Liquid cultures of Escherichia coli K-12, Escherichia coli 0157117 (ATCC 35150), Salmonella enterica serovar Typhimurium LT2, and Staphylococcus aureus (ATCC 12600) were grown with aeration at 35° C. in sterile Mueller-Hinton broth (Becton-Dickinson, Sparks, Md.) until slightly turbid. The turbidity was then adjusted to 0.5 McFarland standard (equivalent to approximately 10⁸ colony forming units per ml).

Liquid cultures of Enterococcus faecalis (ATCC 19433) and Streptococcus pyogenes (ATCC 19615) were grown with aeration at 35° C. in sterile Trypticase Soy broth (Becton-Dickinson, Sparks, Md.) until slightly turbid. The turbidity was then adjusted to 0.5 McFarland standard (equivalent to approximately 10⁸ colony forming units per ml).

2. A two fold dilution series of the ERA-3 product was prepared in sterile Mueller-Hinton (or Trypticase Soy) broth.
3. The standardized cell suspension was diluted 1:100 (to 10⁶ cfu per ml) with sterile Mueller-Hinton (or Trypticase Soy) broth. On ml of the diluted cells was added to a culture tube containing 1 ml of the product at an appropriate dilution. Thus, the final density of the cell inoculum was 5×10⁵ cfu per ml. The final dilutions of the products in the culture tubes were 1:32, 1:64, 1:128, and 1:256. No-product (broth only) and no-cell controls were also included. Five replicate culture tubes were prepared for each dilution of each product and the controls.
4. The tubes were incubated with aeration at 35° C. for 16-20 hours. The culture turbidity was measured by visible-light spectroscopy (i.e., the absorbance of the culture at a wavelength of 625 nm) relative to an H₂O blank, and the results were recorded for each culture tube. The absorbance values were adjusted by subtracting the baseline absorbance of the culture medium (obtained from the no-cell controls).
5. For each of the five replicate culture tubes, the average absorbance, standard deviation, and % inhibition were calculated from the collected data and are summarized in the Tables below.

TABLE 1

| Dilutions: | | | | |
|---|---|---|---|---|
| 1/32 | 1/64 | 1/128 | 1/256 | No ERA-3 |

Salmonella enterica LT2

| | | | | | |
|---|---|---|---|---|---|
| Tube 1 | 0.000 | 0.546 | 1.188 | 1.466 | 1.456 |
| Tube 2 | 0.000 | 0.576 | 1.234 | 1.351 | 1.385 |
| Tube 3 | 0.001 | 0.486 | 1.272 | 1.331 | 1.392 |
| Tube 4 | 0.001 | 0.485 | 1.240 | 1.240 | 1.372 |
| Tube 5 | 0.002 | 0.613 | 1.242 | 1.308 | 1.363 |
| Average | 0.001 | 0.541 | 1.235 | 1.339 | 1.394 |
| Std. Dev. | 0.00083666 | 0.05611328 | 0.03021920 | 0.08230857 | 0.03665106 |
| % Inhibition | 99.9 | 61.2 | 11.4 | 3.9 | |

Escherichia coli O157:H7

| | | | | | |
|---|---|---|---|---|---|
| Tube 1 | 0.003 | 0.000 | 0.858 | 1.289 | 1.320 |
| Tube 2 | −0.001 | 0.000 | 0.919 | 1.232 | 1.333 |
| Tube 3 | −0.002 | −0.002 | 0.865 | 1.161 | 1.329 |
| Tube 4 | −0.003 | | 0.891 | 1.079 | 1.317 |
| Tube 5 | 0.006 | 0.002 | 0.906 | 1.156 | 1.289 |
| Average | 0.001 | 0.000 | 0.888 | 1.183 | 1.318 |
| Std. Dev. | 0.00378153 | 0.00163299 | 0.02609023 | 0.08010181 | 0.01725688 |
| % Inhibition | 99.9 | 100.0 | 32.6 | 10.2 | |

Escherichia coli K-12

| | | | | | |
|---|---|---|---|---|---|
| Tube 1 | 0.003 | −0.001 | 1.127 | 1.263 | 1.663 |
| Tube 2 | −0.004 | 0.007 | 1.204 | 1.287 | 1.715 |
| Tube 3 | 0.007 | −0.004 | 1.152 | 1.266 | 1.655 |
| Tube 4 | 0.009 | −0.006 | 1.244 | 1.291 | 1.625 |
| Tube 5 | −0.001 | 0.002 | 1.165 | 1.254 | 1.578 |
| Average | 0.003 | 0.000 | 1.178 | 1.272 | 1.647 |
| Std. Dev. | 0.00540370 | 0.00512835 | 0.04603586 | 0.01602186 | 0.05046979 |
| % Inhibition | 99.8 | 100.0 | 28.5 | 22.8 | |

Enterococcus faecalis ATCC 19433

| | | | | | |
|---|---|---|---|---|---|
| Tube 1 | −0.005 | 0.276 | 0.965 | 0.914 | 1.142 |
| Tube 2 | −0.001 | 0.378 | 0.931 | 0.942 | 1.144 |
| Tube 3 | −0.004 | 0.304 | 0.949 | 1.021 | 1.132 |
| Tube 4 | 0.002 | 0.277 | 0.870 | 0.770 | 1.142 |
| Tube 5 | 0.004 | 0.270 | 0.897 | 0.886 | 1.149 |
| Average | −0.001 | 0.301 | 0.922 | 0.907 | 1.142 |
| Std. Dev. | 0.00383406 | 0.04500000 | 0.03868850 | 0.09148661 | 0.00618061 |
| % Inhibition | 100.0 | 73.6 | 19.3 | 20.6 | |

Streptococcus py pyogenes Group A ATTC 19615

| | | | | | |
|---|---|---|---|---|---|
| Tube 1 | 0.000 | 0.013 | 0.501 | 0.583 | 0.728 |
| Tube 2 | −0.002 | 0.020 | 0.461 | 0.788 | 0.718 |
| Tube 3 | 0.004 | 0.009 | 0.430 | 0.658 | 0.725 |
| Tube 4 | 0.032 | 0.009 | 0.460 | 0.389 | 0.724 |
| Tube 5 | 0.006 | 0.035 | 0.388 | 0.640 | 0.733 |
| Average | 0.008 | 0.017 | 0.448 | 0.612 | 0.726 |
| Std. Dev. | 0.01378405 | 0.01091788 | 0.04197023 | 0.14529728 | 0.00550454 |
| % Inhibition | 98.9 | 97.7 | 38.3 | 15.7 | |

Staphylococcus aureus subspecies aureus ATCC 12600

| | | | | | |
|---|---|---|---|---|---|
| Tube 1 | 0.002 | 0.034 | 0.293 | 0.389 | 1.727 |
| Tube 2 | −0.002 | 0.023 | 0.240 | 0.392 | 1.724 |
| Tube 3 | 0.014 | 0.022 | 0.210 | 0.239 | 1.815 |
| Tube 4 | 0.001 | 0.021 | 0.211 | 0.371 | 1.712 |
| Tube 5 | 0.003 | 0.022 | 0.184 | 0.320 | 1.758 |
| Average | 0.004 | 0.024 | 0.228 | 0.342 | 1.747 |
| Std. Dev. | 0.00610737 | 0.00541295 | 0.04158485 | 0.06450349 | 0.04152951 |

The conclusion drawn from these experimental results is that the ERA-3 product completely inhibits the growth of all six bacterial strains under the test conditions at a dilution of 1:32, which corresponds to a working concentration of approximately 3%.

### Example 2

The following experiment served to test the susceptibility of both Gram-positive and Gram-negative bacteria to the aqueous silicon ERA-3.

Two organisms were tested. The Gram-negative bacterium was Vibrio cholerae, the causative agent of cholera. Four different stains were tested: two strains of V. cholerae O1, the 6^{th} pandemic strain O395 and the 7^{th} pandemic strain N16961; and two strains of non-O1 V. cholerae, CI-1 (isolated from a child hospitalized in Lubbock) and 2076-7931. the Gram-positive bacterium was methicillin-resistant Staphylococcus aureus (MRSA) ATCC 43300. This is a clinical strain originally isolated in Kansas.

The method used was the broth microdilution method for susceptibility testing of antibacterial agent as recommended by the Clinical and Laboratory Standards Institute (CLSI). The detailed procedure is as follows:

1. A culture of the test organism was grown at 35° C. with aeration in sterile Cation-adjusted Mueller-Hinton broth until slightly turbid, and the turbidity was then adjusted to a 0.5 McFarland standard [equivalent to approximately 10⁸ colony-forming units (cfu) per ml].
2. Appropriate dilutions of the ERA-3 product were prepared in sterile Cation-adjusted Mueller-Hinton broth such that the final concentrations of the product were 0.5%, 1.0%, 2.0%, 3.0%, and 5.0%. A 0% (no-product) control was also included.
3. Appropriate volumes of the standardized cell suspension were added to the dilutions of the product to achieve a final cell density of 5×10⁵ cfu per ml. The dilutions were then aliquoted into the wells of a 96 well microtiter plate (with a volume of 0.2 ml per well).
4. The first two wells in each column of the microtiter plate were reserved for a no-cell control, and the remaining six wells were used for cell-inoculated dilutions of the product. Columns 1-6 represented the 0%, 0.5%, 1.0%, 2.0%, 3.0%, and 5.0% concentrations, respectively.
5. The microtiter plates were incubated at 35° C. for 16-20 hours. The culture turbidity was measured by visible-light spectroscopy (i.e., the absorbance of the culture at a wavelength of 490 nm) using a Biotek PowerWave microtiter plate reader (Biotek Instruments, Inc.) and the results were recorded automatically using the manufacturer's Gen5™ software.
6. The baseline absorbance of the wells containing the uninoculated dilutions (no-cell controls) was subtracted from the absorbances of the wells containing the cell-inoculated dilutions of the product. For each set of six replicate wells, the average (mean) absorbance, % inhibition, and standard deviation were calculated from the collected data.

The results are summarized in Table 2 below.

TABLE 2
ERA-3 Concentration

| | | | | | |
|---|---|---|---|---|---|
| 0.0% | 0.5% | 1.0% | 2.0% | 3.0% | 5.0% |

Staphylococcus aureus ATCC 43300 (MRSA)

| | | | | | | |
|---|---|---|---|---|---|---|
| Sample | | | | | | |
| 1 | 0.307 | 0.246 | 0.147 | 0.013 | −0.004 | −0.031 |
| 2 | 0.329 | 0.243 | 0.134 | 0.012 | −0.003 | 0.024 |
| 3 | 0.360 | 0.243 | 0.138 | 0.015 | 0.000 | −0.029 |
| 4 | 0.369 | 0.279 | 0.148 | 0.022 | 0.003 | −0.025 |
| 5 | 0.376 | 0.274 | 0.152 | 0.018 | 0.002 | −0.021 |
| 6 | 0.440 | 0.278 | 0.172 | 0.017 | 0.004 | −0.009 |
| 7 | 0.285 | 0.190 | 0.128 | 0.015 | 0.003 | −0.007 |
| 8 | 0.294 | 0.209 | 0.139 | 0.014 | −0.001 | 0.000 |
| 9 | 0.274 | 0.211 | 0.136 | 0.013 | 0.001 | −0.008 |
| 10 | 0.247 | 0.218 | 0.132 | 0.018 | 0.003 | −0.010 |
| 11 | 0.251 | 0.220 | 0.131 | 0.016 | 0.002 | −0.009 |
| 12 | 0.288 | 0.247 | 0.142 | 0.013 | 0.004 | −0.001 |
| AVERAGE | 0.318 | 0.238 | 0.142 | 0.016 | 0.001 | −0.011 |
| STD DEV | 0.058 | 0.029 | 0.012 | 0.003 | 0.003 | 0.015 |
| % Inhibition | 0.0% | 25.2% | 55.3% | 95.0% | 99.7% | 100.0% |

Vibrio cholerae

| | | | | | | |
|---|---|---|---|---|---|---|
| Strain | | | | | | |
| N16961 | 0.976 | 0.252 | 0.007 | 0.009 | −0.004 | 0.000 |
| N16961 | 0.660 | 0.176 | 0.005 | 0.004 | −0.007 | 0.003 |
| CI-1 | 1.289 | 0.555 | 0.009 | 0.007 | −0.007 | −0.004 |
| CI-1 | 0.793 | 0.576 | 0.599 | 0.001 | −0.010 | −0.009 |
| 2076 | 1.710 | 0.690 | 0.016 | 0.004 | −0.009 | −0.014 |
| 2076 | 1.356 | 0.675 | 0.025 | 0.002 | −0.007 | −0.016 |
| 2076 | 1.121 | 0.550 | 0.005 | 0.001 | −0.009 | −0.016 |
| 2076 | 1.070 | 0.509 | 0.002 | −0.004 | −0.008 | −0.010 |
| O395 | 0.060 | 0.001 | 0.006 | 0.008 | −0.006 | −0.007 |

This minimum inhibitory concentration (MIC) of the product was the 3.0% concentration for the S. aureus strain. Although the 2.0% concentration was not completely inhibitory, growth of the S. aureus cultures under these conditions was minimal (approximately 5% of the growth yield observed in the 0% cultures). All five of the V. cholerae strains gave comparable results: the MIC of the product was the 1.0% concentration for four of the five strains, and growth of the fifth strain (CI-1) was completely inhibited at the 2.0% concentration.

The conclusions drawn from these results are that under test conditions the product completely inhibits the growth of all of the tested strains at a concentration of 3.0%.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A method of inhibiting bacteria comprising contacting the surface with a stable, aqueous silicon solution.

2. The method of claim 1, wherein the bacteria is a Gram-positive bacteria.

3. The method of claim 1, wherein the bacteria is a Gram-negative bacteria.

4. The method of claim 1, wherein aqueous silicon solution is at a concentration of at least 0.5%.

5. The method of claim 1, wherein the aqueous silicon solution is at a concentration of at least 1.0%.

6. The method of claim 1, wherein the aqueous silicon solution is at a concentration of at least 2.0%.

7. The method of claim 1, wherein the aqueous silicon solution is at a concentration of at least 3.0%.

8. The method of claim 1, wherein the aqueous silicon solution is at a concentration of greater than 3.0%.

9. The method of claim 1, wherein the aqueous silicon solution comprises SiO₂ and Na₂O in a ratio, by mass, of at least 3.8.

10. The method of claim 1, wherein the aqueous silicon solution is sprayed on the surface.

11. The method of claim 1, wherein the aqueous silicon solution is contacted to the surface via a sponge or cloth.

12. A method of treating crops for bacterial contamination comprising contacting the crops with an aqueous silicon solution.

13. A stable, aqueous solution for inhibiting bacteria comprising SiO₂ and Na₂O in a ratio, by mass, of at least 3.8.

14. The stable, aqueous solution of claim 13, wherein said bacteria is a Gram-positive bacteria.

15. The stable, aqueous solution of claim 13, wherein said bacteria is a Gram-negative bacteria.

16. The stable, aqueous solution of claim 13, further comprising aqueous silicon at a concentration of at least 0.5%.

17. The stable, aqueous solution of claim 13, further comprising aqueous silicon at a concentration of at least 1.0%.

18. The stable, aqueous solution of claim 13, further comprising aqueous silicon at a concentration of at least 2.0%.

19. The stable, aqueous solution of claim 13, further comprising aqueous silicon at a concentration of at least 3.0%.

20. The stable, aqueous solution of claim 13, further comprising aqueous silicon at a concentration of greater than 3.0%.
